(19) United States
(12) Patent Application Publication
(10) Pub. No.: US 2016/0065394 A1
(43) Pub. Date: Mar. 3, 2016

(54) SERIALIZER/DESERIALIZER WITH INDEPENDENT EQUALIZATION ADAPTATION FOR REDUCING EVEN/ODD EYE DISPARITY

(71) Applicant: Avago Technologies General IP (Singapore) Pte. Ltd., Singapore (SG)

(72) Inventors: Vladimir Sindalovsky, Warrington, PA (US); Mohammad Shafiul Mobin, Orefield, PA (US); Dwight David Daugherty, Ephrata, PA (US)

(21) Appl. No.: 14/469,196

(22) Filed: Aug. 26, 2014

(51) Int. Cl. H04L 25/03; H04L 7/00

(52) U.S. Cl. CPC H04L 25/03012; H04L 7/0033

(57) ABSTRACT

A method for reducing a disparity between even and odd eye characteristics in recovered data includes: receiving an input serial data stream; performing independent data slicing of even and odd components in the serial data stream to generate corresponding even and odd discrete-time data samples, respectively; performing independent error slicing of even and odd components in the serial data stream to generate corresponding even and odd discrete-time error samples, respectively; deserializing the even and odd discrete-time data and error samples to generate the recovered data and recovered error, respectively; and controlling respective offsets for error slicing of the even and odd components independently so as to reduce the disparity between even and odd eye characteristics in the recovered data.

### FIELD OF INVENTION

The present invention relates generally to electrical and electronic circuitry, and more particularly relates to data communications.

### BACKGROUND

It is well known that when a signal passes through a band-limited channel it will suffer waveform distortion. For example, FIG. 1 conceptually depicts a bipolar data channel input sequence waveform 102 and a corresponding data channel output sequence waveform 104. The input sequence waveform 102 is shown synchronized to a bit clock waveform 106, which is typically half the bit rate frequency. As apparent from FIG. 1, the output sequence waveform 104 exhibits distortion, such as, for example, oscillations (e.g., ringing, overshoot, undershoot) on the rising and falling edges, as well as delay, attributable, at least in part, to the signal being passed through a band-limited channel. This delay is signal frequency dependent and creates an effect known as intersymbol interference (ISI). As the data rate increases, the waveform distortion increases, requiring special techniques for the signal recovery.

In a digital communication system, an eye pattern, also known as an eye diagram, provides a convenient means of evaluating the combined effects of channel noise and ISI on the performance of a baseband transmission. It is essentially a synchronized superposition of all possible realizations of a signal of interest viewed within a prescribed signaling interval (e.g., unit interval (UI)). Several system performance characteristics can be determined by analyzing an eye pattern. For example, if signals are too long, too short, poorly synchronized with the system clock, have too much undershoot or overshoot, etc., this can be readily observed from the eye pattern. An open eye pattern corresponds to minimal signal distortion, while closure of the eye pattern is generally indicative of distortion of the signal waveform due to ISI and channel noise as the data rate increases.

### SUMMARY

In accordance with an embodiment of the invention, a method for reducing a disparity between even and odd eye characteristics in recovered data includes: receiving an input serial data stream; performing independent data slicing of even and odd components in the serial data stream to generate corresponding even and odd discrete-time data samples, respectively; performing independent error slicing of even and odd components in the serial data stream to generate corresponding even and odd discrete-time error samples, respectively; deserializing the even and odd discrete-time data and error samples to generate the recovered data and recovered error, respectively; and controlling respective offsets for error slicing of the even and odd components independently so as to reduce the disparity between even and odd eye characteristics in the recovered data. Other embodiments of the invention include, but are not limited to, being manifest as a data communication apparatus, an integrated circuit including at least one data communication apparatus, a method for reducing even/odd eye disparity in a serializer/deserializer (SerDes), and an electronic system. Additional and/or other embodiments of the invention are described in the following written description, including the claims, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a graph conceptually depicting waveform distortion of a bipolar input sequence signal when it passes through a band-limited channel;

FIG. 2 is a block diagram depicting at least a portion of an exemplary data communication system which can be modified to implement one or more embodiments of the present invention;

FIG. 3 is an eye diagram depicting inputs to data slicers in an exemplary serializer/deserializer (SerDes) receiver shown in FIG. 2 which can be used to conceptually illustrate a least mean squares (LMS) adaptation methodology suitable for setting one or more parameters in the SerDes receiver and/or transmitter;

FIG. 4 is a block diagram depicting at least a portion of an exemplary SerDes receiver, according to an embodiment of the present invention;

FIG. 5 is a block diagram depicting at least a portion of an exemplary SerDes receiver, according to another embodiment of the present invention; and

FIG. 6 depicts a computer system that may be useful in implementing at least a portion of one or more embodiments and/or elements of the invention.

It is to be appreciated that the drawings described herein are presented for illustrative purposes only. Moreover, common but well-understood elements and/or features that may be useful or necessary in a commercially feasible embodiment may not be shown in order to facilitate a less hindered view of the illustrated embodiments.

### WRITTEN DESCRIPTION

Embodiments of the invention will be described herein in the context of illustrative serializer/deserializer (SerDes) receiver circuitry for use, for example, in a data communication system. It should be understood, however, that embodiments of the invention are not limited to these or any other particular circuit arrangements or applications. Rather, embodiments of the invention are more broadly applicable to techniques for reducing an error rate in recovered data in a data communication system. In this regard, embodiments of the invention provide an apparatus and methodology for beneficially reducing a disparity between even and odd eye characteristics in a SerDes by providing independent equalization adaptation of even and odd data eyes of a received serial data stream.

It will become apparent to those skilled in the art given the teachings herein that numerous modifications can be made to the illustrative embodiments shown that are within the scope of the claimed invention. That is, no limitations with respect to the embodiments shown and described herein are intended or should be inferred.

As a preliminary matter, for purposes of clarifying and describing embodiments of the invention, the following table provides a summary of certain acronyms and their corresponding definitions, as the terms are used herein:

Table of Acronym Definitions

| Acronym | Definition |
|---|---|
| ISI | Intersymbol interference |
| UI | Unit interval |
| SerDes | Serializer/deserializer |
| LMS | Least mean squares |
| TX | Transmitter |
| PISO | Parallel input serial output |
| FIR | Finite impulse response |
| RX | Receiver |
| VGA | Variable gain amplifier |
| LEQ | Linear equalizer (or equalization) |
| DFE | Decision feedback equalizer (or equalization) |
| CDR | Clock and data recovery |
| TDM | Time-division multiplexing |

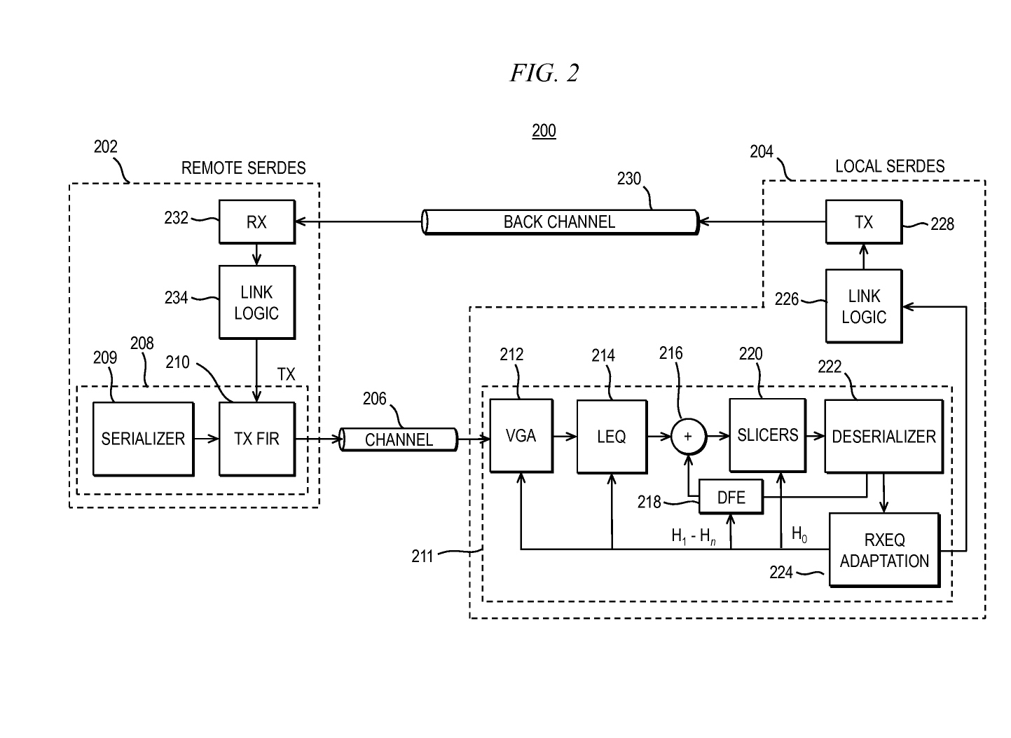

FIG. 2 is a block diagram depicting at least a portion of an exemplary data communication system 200 which can be modified to incorporate one or more embodiments of the present invention. The system 200 includes a remote SerDes device 202 configured to transmit serial data to a local SerDes device 204 via a communication channel 206 established therebetween. The remote SerDes 202 includes a transmitter (TX) 208 which comprises a serializer 209 operative to convert a parallel input data pattern into a serial data stream. The serializer 209 can be implemented using, for example, a multiplexer or other parallel input serial output (PISO) device, as will become apparent to those skilled in the art. The serial data stream generated by the serializer 209 is supplied to a digital finite impulse response (FIR) filter 210 which is operative to perform feed-forward equalization on the serial transmit data stream supplied to the channel 206.

The local SerDes 204 includes a receiver (RX) 211 configured to receive the serial transmit data stream from the channel 206. The serial data, degraded after transmission through the channel 206, undergoes amplification by a variable gain amplifier (VGA) 212 included in the receiver 211. The serial data is enhanced using equalization by a linear equalizer (LEQ) 214 configured to compensate for potential low-pass filtering characteristics of the channel 206. The equalized serial data generated by the linear equalizer 214 is supplied to a summing node (e.g., adder) 216 where additional enhancement is implemented using a decision feedback equalizer (DFE) 218.

Subsequent to decision feedback equalization of the serial data stream, the serial data is sampled using slicers 220; slicers 220 incorporate data slicers, transition slicers and error slicers. The slicers 220 are operative to convert the serial data stream into discrete-time digital domain samples. The sampled data generated by the slicers 220 is then deserialized using a deserializer 222 coupled with an output of the slicers. Outputs generated by the deserializer 222 are used as the recovered data. The recovered data is also used to generate parameters for equalization adaptation, or other post-processing. In this regard, a receiver equalization (RXEQ) adaptation module 224 included in the receiver 211 is configured to receive at least a portion of the recovered data from the deserializer 222 and to generate, as a function of the recovered data, one or more parameters used in implementing the equalization adaptation process, for example in generating a desired offset for the error slicers 220 used in a least mean squares (LMS) adaptation algorithm and decision feedback equalization coefficients H₁ through Hₙ, where n is an integer. Equalization coefficient H₀ is supplied as a vertical offset to the error slicers 220, while one or more of the equalization coefficients H₁ through Hₙ are supplied to the decision feedback equalizer 218, linear equalizer 214 and variable gain amplifier 212 in a closed-loop feedback arrangement.

The adaptation parameters for the remote transmitter FIR filter 210, taken as an output of the receiver equalization adaptation module 224, are supplied to link logic 226 in the local SerDes device 204 which is configured to format the transmitter FIR adaptation data for transmission by a transmitter 228 in the local SerDes to a corresponding receiver 232 in the remote SerDes 202 via a back channel 230 established between the local SerDes and the remote SerDes. The data received by the receiver 232 in the Remote SerDes 202 is then supplied to link logic 234 where it is reformatted for use by the transmitter FIR filter 210. In this manner, one or more parameters used by the transmitter FIR filter 210 in the feed-forward equalization of the serial transmit data stream are modified as a function of the data received from the local SerDes so as to configure the remote transmitter FIR filter 210 for a more optimal eye opening at the receiver 211.

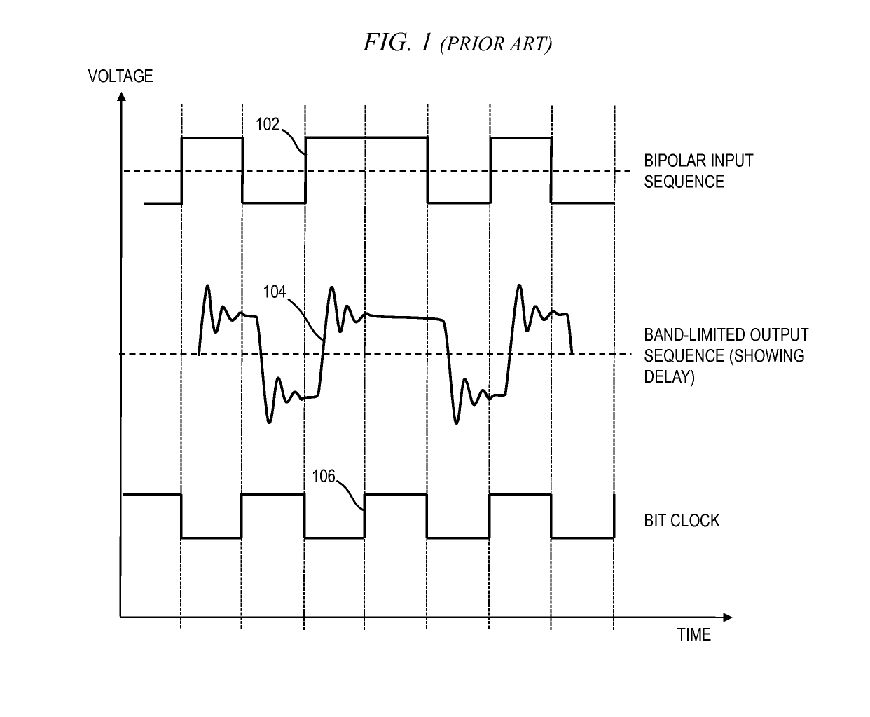

In order to make the hardware design feasible for high serial data rates, the equalized serial data stream generated by the linear equalizer 214, in one or more embodiments, is split into two data paths; namely, an even data path and an odd data path. The serial data is sampled by the slicers 220 at half data rate, taking one sample from the even data path and one sample from the odd data path for each period of a sampling clock used by the slicers in generating the discrete-time digital domain samples. This approach is also used by the corresponding transmitter 208 in the remote SerDes 202. However, while this approach increases a feasibility of the hardware implementation, it also creates artifacts in the transmitted data, producing an inequality of a horizontal eye opening between the even and odd data paths due to duty cycle distortion of the half data rate (two unit interval (UI)) bit clock (as shown in FIG. 1, by way of example). This disparity between even and odd horizontal eye openings also results in a disparity between even and odd vertical eye openings, which is indicative of reduced jitter and noise tolerance, and thus an increased error rate in the recovered data.

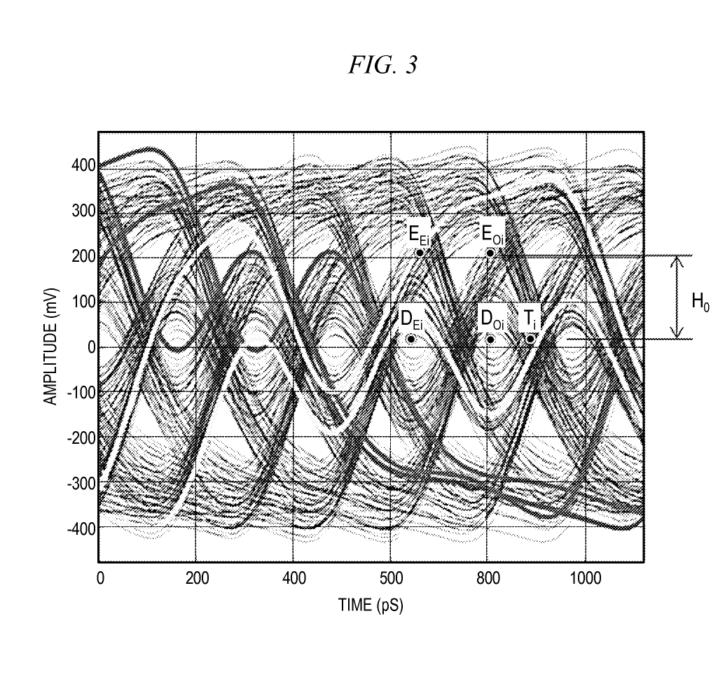

Since many of the parameters used in the transmitter and receiver of a SerDes are variable, it is desirable to set them to optimal values. One way to more optimally control the transmitter and receiver parameters, particularly in a changing and initially unpredictable environment, is to employ real-time adaptation. A standard adaptation algorithm used in a SerDes transmitter and receiver is LMS, which uses data and error samples for adaptation. An example of serial data sampling for this algorithm will be discussed below with reference to FIG. 3.

More particularly, FIG. 3 is an eye diagram depicting inputs to the slicers 220 in the exemplary SerDes receiver 211 shown in FIG. 2 which can be used to conceptually illustrate an LMS adaptation algorithm suitable for setting one or more parameters in the SerDes receiver and/or remote transmitter. In FIG. 3, transition samples, Tᵢ, where i represents a given sampling interval, are aligned, such as, for example, by clock and data recovery (CDR) circuitry, to a statistical middle of all data eye traces crossing zero level. This places data samples, D_{Ei} (even) and D_{Oi} (odd), generated by data slicers in the slicers 220 approximately in the middle of the eye opening. Error samples, E_{Ei} (even) and E_{Oi} (odd), generated by error slicers in the slicers 220 have the same timing as the corresponding data slicers but are vertically offset by ±H₀, as shown in FIG. 3 for positive offset as an example. Typically, one error slicer is used per eye.

The value of the vertical offset is adapted, in one or more embodiments, using the LMS algorithm to place an error slicer in the statistical middle of all data positive eye traces, or alternatively negative eye traces, at the sampling time. An LMS algorithm for H₀ adaptation can be expressed in pseudo code as follows:

H₀= (̅D̅ᵢ̅Λ̅E̅s̅i̅g̅n̅ᵢ̅)̅?Σ₀^{∞} (̅D̅ᵢ̅Λ̅E̅ᵢ̅)̅, (1)

where “̂” is a symbol used to represent an exclusive OR logic operation, and DᵢΛEsignᵢ tests if the data, Dᵢ, has the same polarity as the error slicer offset, Esignᵢ. The “?” symbol represents a condition placed on the equation preceding it. Specifically, if the expression (DᵢΛEsignᵢ) is false, then and only then is the subsequent summation (E₀^{∞} (̅D̅ᵢ̅Λ̅E̅ᵢ̅)̅) executed. If the data does not have the same polarity as the error slicer offset, the error slicer cannot be used for the error evaluation, and the corresponding data is discarded for adaptation.

A gain of the VGA 212 in FIG. 2 is controlled, at least in part, based on H₀ adaptation to achieve a desired vertical data eye opening. DFE coefficients are adapted in a similar manner, as expressed below:

Hₙ= (̅D̅ᵢ̅Λ̅E̅s̅i̅g̅n̅ᵢ̅)̅?Σ₀^{∞} (̅D̅ᵢ̅₋̅ₙ̅Λ̅E̅ᵢ̅)̅, (2)

where n is an integer which represents the decision feedback coefficient number in the general sense.

LMS-based linear equalization, which is implemented, for example, in the linear equalizer 214 in the SerDes receiver 211 shown in FIG. 2, is adapted, in one or more embodiments, using a multiple-tap averaging methodology, which can be expressed as follows for a four-tap case:

LEQ= (̅D̅ᵢ̅Λ̅E̅s̅i̅g̅n̅ᵢ̅)̅?Σ₀^{∞} (̅D̅ᵢ̅ₕ̅Λ̅E̅ᵢ̅)̅, (3)

where the term Dᵢₕ in equation (3) represents an average of a prescribed number of previous samples (e.g., Dᵢ₋₄ through Dᵢ₋₁). It is to be understood that embodiments of the invention are not limited to any specific number of taps used in the averaging methodology. When initially all of the receiver parameters in the local SerDes 204 are adapted to the incoming serial signal, back channel adaptation of the transmitter FIR filter 210 in the remote SerDes 202 shown in FIG. 2 is performed, in one or more embodiments, to thereby further enhance the quality of the incoming serial data stream received from the channel 206.

Remote transmitter FIR filter coefficients to be adapted are typically pre- and postcursor coefficients, CM1 and CP1, respectively, where “CM1” is defined as “coefficient minus one” (i.e., precursor) and CP1 is defined as “coefficient plus one” (i.e., postcursor). With reference again to FIG. 2, the adaptation algorithm implemented in the local SerDes receiver 211, in one or more embodiments, defines a prescribed increment and decrement for the corresponding remote transmitter FIR filter coefficients used by the transmitter FIR filter 210. In a back channel adaptation methodology, requests to increment or decrement the corresponding transmitter FIR filter coefficients are sent by the transmitter 228 in the local SerDes 204, through the back channel 230, to the receiver 232 in the remote SerDes 202. The link logic 234 in the remote SerDes 202 then interprets the requests and sends an acknowledgement to the receiver 211 in the local SerDes 204. Since the back channel 230 is not necessarily adapted to high data rate transmissions, back channel requests are preferably sent at a lower rate using, for example, a simplified encoding methodology, such as, but not limited to, Manchester encoding.

Known methods of VGA, LEQ, and DFE adaptation do not make any distinction between even and odd eyes but rather use averaging between even and odd eyes, utilizing the same parameters for gain, analog (linear) equalization, error slicer offset, and DFE coefficients. This leads to a non-optimal placement of error slicers in the two eyes, resulting in inferior equalization adaptation in the presence of even/odd eye disparity.

In accordance with embodiments of the invention, in order to reduce the disparity between even and odd eye sizes, equalization adaptation is performed independently for even and odd data samples. It is to be appreciated that while the apparatus and methodologies described herein are applicable to a half data rate clock used in the transmitter and receiver for serialization/deserialization of the data, techniques in accordance with one or more embodiments of the invention are equally applicable to alternative (e.g., slower) clock architectures, with modifications that will become readily apparent to those skilled in the art given the teachings herein.

First, one or more embodiments of the invention split even and odd error slicer offset (H₀) adaptation into separate expressions. Specifically, equation (1) above is re-written as follows:

H₀^{E}= (̅D̅₂̅ᵢ̅Λ̅E̅s̅i̅g̅n̅₂̅ᵢ̅)̅?Σ₀^{∞} (̅D̅₂̅ᵢ̅Λ̅E̅₂̅ᵢ̅)̅, and

H₀^{O}= (̅D̅₂̅ᵢ̅₊̅₁̅Λ̅E̅s̅i̅g̅n̅₂̅ᵢ̅₊̅₁̅)̅?Σ₀^{∞} (̅D̅₂̅ᵢ̅₊̅₁̅Λ̅E̅₂̅ᵢ̅₊̅₁̅)̅, (4)

where H₀^{E} represents H₀ adaptation corresponding to the even eye and H₀^{O} represents H₀ adaptation corresponding to the odd eye; that is, equations (4) above accumulate H₀ offset separately for even and odd eyes as H₀^{E} and H₀^{O}, respectively. This allows for placement of corresponding error slicers in the statistical middle of all traces in each of the eyes independently. More optimally placed error slicers in the presence of even/odd eye disparity will provide for an enhanced LMS adaptation of at least the DFE 218 shown in FIG. 2. Furthermore, since H₀ offset with a desirable target range is often used for VGA adaptation, independently implementing error slicer offset (H₀) adaptation for even and odd eyes provides options for VGA adaptation including, but not limited to, using an average of H₀^{E} and H₀^{O}, using a minimum of H₀^{E} and H₀^{O}, and using a maximum of H₀^{E} and H₀^{O}, according to embodiments of the invention.

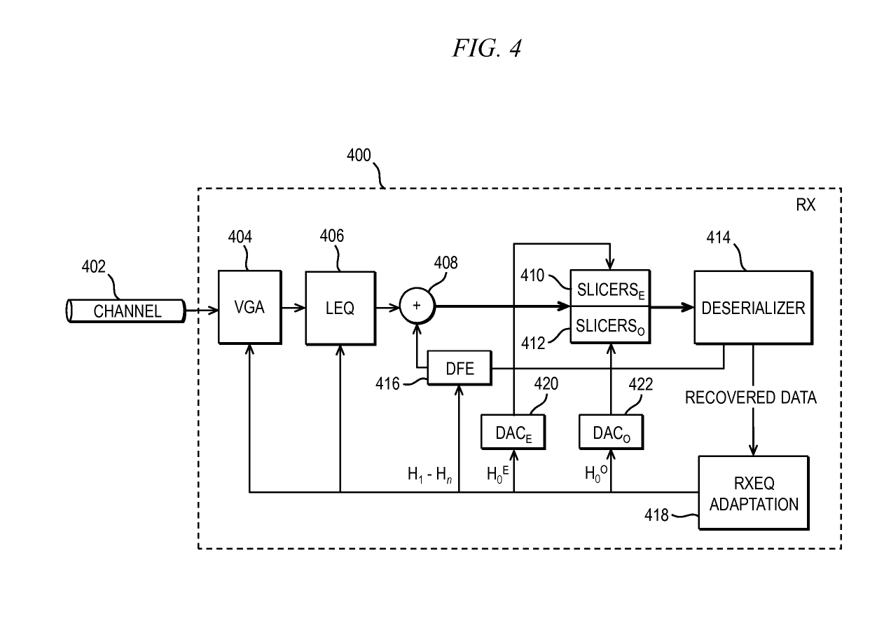

By way of example only and without limitation, FIG. 4 is a block diagram depicting at least a portion of an exemplary SerDes receiver 400, according to an embodiment of the present invention. As will be described in further detail below, the receiver 400 is configured to provide separate and independent even/odd eye H₀ adaptation. As shown in FIG. 4, the receiver 400, which may be included in a local SerDes device, is configured to receive serial data, transmitted, for example, by a remote SerDes device, from a communication channel 402 established between the local and remote SerDes devices. The receiver 400 includes a variable gain amplifier (VGA) 404 operatively coupled with the channel 402, a gain of the VGA being controlled as a function of a first control signal supplied to the VGA. The serial data, which may be degraded after transmission through the channel 402, undergoes amplification by the VGA 404 to produce an amplified serial data stream.

The amplified serial data generated by the VGA 404 is optionally enhanced using equalization by a linear (i.e., analog) equalizer (LEQ) 406 coupled with the VGA. In embodiments that do not employ linear equalization, the LEQ 406 can be eliminated. The linear equalizer 406 is configured to compensate for potential low-pass filtering characteristics of the channel 402 and to generate an equalized serial data stream. One or more equalization characteristics of the linear equalizer 406 are controlled as a function of a second control signal supplied to the linear equalizer. The equalized serial data generated by the linear equalizer 406 is supplied to an adder 408, or alternative summation element (e.g., summing node) which, in this embodiment, is configured to facilitate further enhancement of the serial data using, for example, decision feedback equalization, as will be described in further detail below.

Subsequent to decision feedback equalization of the serial data stream, the serial data is sampled using data slicers. In this embodiment, the serial data stream is split into separate even and odd components. The receiver 400 comprises first slicers 410, configured to convert the even components in the serial data stream into corresponding even discrete-time digital domain samples, and second slicers 412, configured to convert the odd components in the serial data stream into corresponding odd discrete-time digital domain samples. It is to be appreciated that each of the slicers 410, 412 comprises data slicers, error slicers and transition slicers. A slicing threshold in each of the error slicers 410, 412 is independently controlled by separate control signals supplied thereto. In this embodiment, error slicers in the first and second slicers 410, 412 are separately controlled; data and transition slicers need not be separately controlled since they do not contribute to vertical offset (e.g., H₀ in FIG. 3) in the eye diagram; that is, data and transition slicers have zero vertical offset.

The even and odd sampled data generated by the even slicers 410 and odd slicers 412, respectively, are deserialized using a deserializer 414 coupled with outputs of the even and odd slicers. Samples generated by the deserializer 414 form the recovered data output of the receiver 400. Transition and data samples after deserialization are used for recovered data and phase detection used in CDR locking to the data; deserialized error samples are used for receiver adaptation.

The recovered data is used to perform decision feedback equalization to further enhance the recovered data output. Specifically, at least a portion of the recovered data is fed back to the adder 408 via a decision feedback equalizer (DFE) 416 which is coupled between the deserializer 414 and the adder in a closed loop feedback configuration. The DFE 416 uses information about previously received samples to reduce or cancel out their ISI contributions from the current decision. One or more parameters of the DFE 416 are controlled as a function of at least a fifth control signal supplied to the DFE.

The recovered data output, in this embodiment, is also used to generate control signals for equalization adaptation, or other post-processing. In this regard, the receiver 400 includes a receiver equalization (RXEQ) adaptation module 418 which is configured to receive at least a portion of the recovered data output from the deserializer 414 and to generate, as a function of the recovered data, one or more control signals used in implementing an equalization adaptation methodology, for example in generating equalization adaptation coefficients H₁ through Hₙ, where n is an integer.

More particularly, an even equalization adaptation coefficient H₀^{E} generated by the receiver equalization adaptation module 418 is supplied to a first digital-to-analog converter (DAC) 420, which in this embodiment is an even DAC (DAC_{E}), configured to convert H₀^{E} to an analog signal which is used to form the third control signal supplied to the even slicers 410 as even error slicer offset. Likewise, an odd equalization adaptation coefficient H₀^{O} generated by the receiver equalization adaptation module 418 is supplied to a second DAC 422, which in this embodiment is an odd DAC (DAC_{O}), configured to convert H₀^{O} to an analog signal which is used to form the fourth control signal supplied to the odd slicers 412 as odd error slicer offset. Thus, separately adapted H₀^{E} and H₀^{O} coefficients are sent to the even and odd DACs 420 and 422, respectively, for converting a digital error slicer offset to respective analog control signals which are, in turn, applied to corresponding even and odd error slicers in the even and odd slicers 410 and 412. In one or more alternative embodiments, a single DAC can be utilized for even and odd conversion using, for example, a time-division multiplexing (TDM) scheme.

Other coefficients generated by the receiver equalization adaptation module 418 (e.g., coefficients H₁ through Hₙ) are used for controlling one or more parameters of the DFE 416, the LEQ 406 and the VGA 404. Specifically, one or more control signals are used to control at least a gain of the VGA 404, the second control signal used to control one or more linear equalization parameters of the LEQ 406, and the coefficients H₁ through Hₙ are used to control one or more decision feedback equalization parameters of the DFE 416, in accordance with one or more embodiments of the invention.

Properly placed error slicers make LMS algorithm for DFE, VGA and LEQ adaptation use correct error terms per equations (2) and (3) above because both error slicers are placed in the statistical middle between inner and outer eyes for both even and odd eyes. While the receiver architecture shown in FIG. 4 achieves improved equalization adaptation, compared to conventional approaches, by independently controlling separate slicers for even and odd data samples, the adaptation for DFE is still averaged between the two eyes not allowing for equalization of the eye opening.

In order to improve the overall performance of equalization adaptation in the SerDes receiver, one or more embodiments of the invention utilize separate adaptation for even and odd DFE coefficients. Modified equations, based on equation (2) above, for split even and odd DFE coefficient adaptation are expressed as follows:

Hₙ^{E}= (̅D̅₂̅ᵢ̅Λ̅E̅s̅i̅g̅n̅₂̅ᵢ̅)̅?Σ₀^{∞} (̅D̅₂̅ᵢ̅₋̅ₙ̅Λ̅E̅₂̅ᵢ̅)̅

Hₙ^{O}= (̅D̅₂̅ᵢ̅₊̅₁̅Λ̅E̅s̅i̅g̅n̅₂̅ᵢ̅₊̅₁̅)̅?Σ₀^{∞} (̅D̅₂̅ᵢ̅₊̅₁̅₋̅ₙ̅Λ̅E̅₂̅ᵢ̅₊̅₁̅)̅ (5)

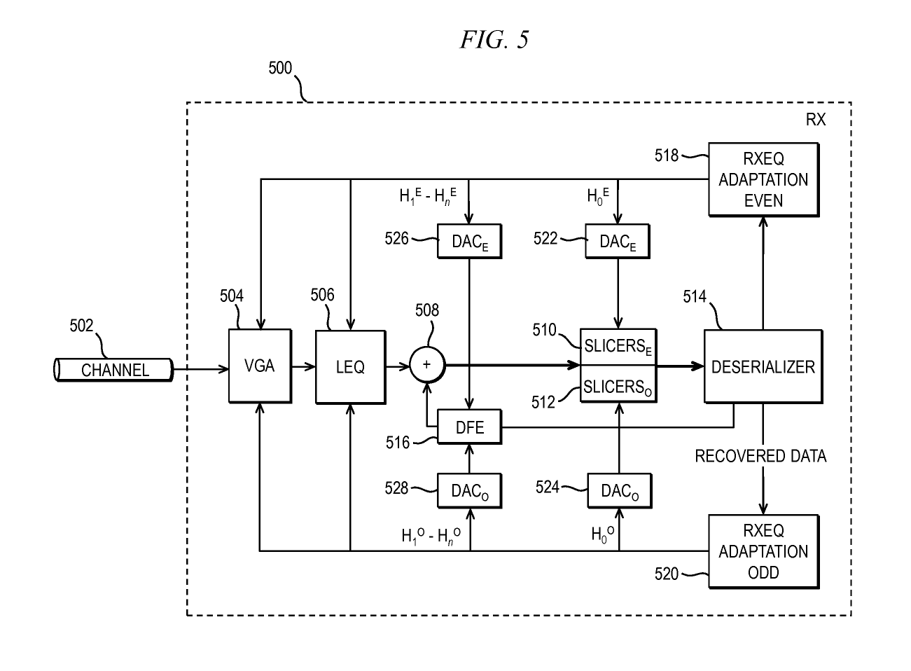

By way of example only and without limitation, FIG. 5 is a block diagram depicting at least a portion of an exemplary SerDes receiver 500, according to another embodiment of the present invention. The receiver 500, which may be included in a local SerDes device, is configured to receive serial data, transmitted, for example, by a remote SerDes device, from a communication channel 502 established between the local and remote SerDes devices. As will be described in further detail below, the receiver 500 is configured to provide separate and independent even and odd DFE coefficients, H₁ through Hₙ, in addition to providing separate even/odd eye H₀ adaptation. The receiver 500 comprises a variable gain amplifier (VGA) 504 operatively coupled with the channel 502, a gain of the VGA being controlled as a function of a first control signal supplied to the VGA. The serial data, which may be degraded after transmission through the channel 502, undergoes amplification by the VGA 504 to produce an amplified serial data stream.

The amplified serial data generated by the VGA 504 is enhanced using equalization by a linear equalizer (LEQ) 506 coupled with the VGA. The linear equalizer 506 is configured to compensate for potential low-pass filtering characteristics of the channel 502 and to generate an equalized serial data stream. One or more equalization characteristics of the linear equalizer 506 are controlled as a function of a second control signal supplied to the linear equalizer. The equalized serial data generated by the linear equalizer 506 is supplied to an adder 508, or alternative summation element which, in this embodiment, is configured to facilitate further enhancement of the serial data using, for example, decision feedback equalization, as will be described in further detail below.

Subsequent to decision feedback equalization of the serial data stream, the serial data is sampled using data slicers. In this embodiment, like in the illustrative receiver 400 shown in FIG. 4, the serial data stream is split into separate even and odd components, starting from the summing element 508, which is implemented, in one or more embodiments, as two summing nodes—even and odd. The receiver 500 comprises first slicers 510, configured to convert the even components in the serial data stream into corresponding even discrete-time digital domain samples, and second slicers 512, configured to convert the odd components in the serial data stream into corresponding odd discrete-time digital domain samples. It is to be appreciated that each of the slicers 510, 512 comprises data slicers, error slicers and transition slicers. A slicing threshold in each of the slicers 510, 512 is independently controlled by separate control signals supplied thereto.

The even and odd sampled data generated by the even slicers 510 and odd slicers 512, respectively, are deserialized using a deserializer 514 coupled with outputs of the even and odd slicers. Samples generated by the deserializer 514 form the recovered data output of the receiver 500. As previously stated, transition and data samples after deserialization are used to generate the recovered data and phase detection used in CDR locking to the data; deserialized error samples are used for receiver adaptation.

The recovered data is used to perform decision feedback equalization to further enhance the recovered data output. Specifically, at least a portion of the recovered data is fed back to the adder 508 (even and odd) via a decision feedback equalizer (DFE) 516 which is coupled between the deserializer 514 and the adder in a closed loop feedback configuration. The DFE 516 uses information about previously received samples to reduce or cancel out their ISI contributions from the current decision. Unlike the DFE 416 in the receiver 400 of FIG. 4, one or more parameters of the DFE 516 are independently controlled as a function of a first set of control signals corresponding to even decision feedback equalization coefficients, H₁^{E} through Hₙ^{E}, and a second set of control signals corresponding to odd decision feedback equalization coefficients, H₁^{O} through Hₙ^{O}, supplied to the DFE. These sets of control signals are used to independently control, as a function of even and odd data samples in the recovered data output, one or more parameters of the decision feedback equalization methodology implemented by the DFE 516.

The recovered data output is also used to generate control signals for equalization adaptation, or other post-processing. In this embodiment, the receiver 500 includes a first receiver equalization (RXEQ) adaptation module 518 which is configured to receive samples in the recovered data output from the deserializer 514 and to generate, as a function of the even error samples, a set of even equalization coefficients, H₀^{E} through Hₙ^{E}, used in implementing an equalization adaptation methodology. In this regard, an adaptation algorithm according to one or more embodiments of the invention utilizes data from both even and odd slicers, but even error slicer information is used for even DFE coefficients, and odd error slicer information is used for odd coefficients, as can be seen from the equations (5) above. The receiver 500 further includes a second receiver equalization (RXEQ) adaptation module 520 which is configured to receive data samples and odd error samples in the recovered data output from the deserializer 514 and to generate, as a function of the odd error samples, a set of odd equalization coefficients, H₀^{O} through Hₙ^{O}, used in implementing the equalization adaptation methodology.

More particularly, an even equalization adaptation coefficient H₀^{E} generated by the even receiver equalization adaptation module 518 is supplied to a first digital-to-analog converter (DAC) 522, which in this embodiment is an even DAC (DAC_{E}), configured to convert H₀^{E} to an analog signal which is used to control the even error slicers 510. Likewise, an odd equalization adaptation coefficient H₀^{O} generated by the odd receiver equalization adaptation module 520 is supplied to a second DAC 524, which in this embodiment is an odd DAC (DAC_{O}), configured to convert H₀^{O} to an analog signal which is used to control the odd error slicers 512. Thus, separately adapted H₀^{E} and H₀^{O} coefficients are sent to the even and odd DACs 522 and 524, respectively, for converting a digital error slicer offset to respective analog control signals which are, in turn, applied to corresponding even and odd error slicers in the even and odd slicers 510 and 512. In one or more alternative embodiments, a single DAC can be utilized for even and odd conversion using, for example, a TDM scheme.

Other coefficients generated by the even and odd receiver equalization adaptation modules 518 and 520 are used for controlling one or more parameters of the DFE 516, the LEQ 506 and the VGA 504. Specifically, one or more coefficients in the set of even coefficients H₁^{E} through Hₙ^{E} generated by the even receiver equalization adaptation module 518 form the first set of control signals used to control one or more decision feedback equalization parameters of the DFE 516. These digital even coefficients H₁^{E} through Hₙ^{E} are first converted to corresponding analog signals using a third DAC 526, which in this embodiment is an even DAC (DAC_{E}), before being supplied to the DFE 516. Likewise, one or more coefficients in the set of odd coefficients H₁^{O} through Hₙ^{O} generated by the odd receiver equalization adaptation module 520 form the second set of control signals used to control one or more decision feedback equalization parameters of the DFE 516. These digital odd coefficients H₁^{O} through Hₙ^{O} are first converted to corresponding analog signals using a fourth DAC 528, which in this embodiment is an odd DAC (DAC_{O}), before being supplied to the DFE 516. As in the case of DACs 522 and 524, DACs 526 and 528 may, in other embodiments, be replaced by a single DAC which is shared between the even and odd samples, such as, for example, using TDM or an alternative multiplexing scheme. One or more of the control signals also form the first control signal used to control at least a gain of the VGA 504, and the second control signal used to control one or more linear equalization parameters of the LEQ 506. Since, in this embodiment, the VGA 504 and LEQ 506 are applied to both even and odd eyes without distinction, the control signals generated by the even and odd receiver equalization adaptation modules 518 and 520 are averaged.

There are at least two techniques for applying H₁ DFE that are suitable for use in accordance with embodiments of the invention; namely, rolled DFE and unrolled DFE. For the rolled DFE methodology, the H₁ value is added to or subtracted from the analog serial signal on-the-fly. Specifically, according to one or more embodiments of the invention, the value of the H₁^{E} even coefficient will be added or subtracted for even eye samples, and the value of the H₁^{O} odd coefficient will be added or subtracted for odd eye samples. The unrolled DFE technique employs two data slicers offset by ±H₁. Post processing of data makes a decision as to which data slicer to use for data recovery based on the digital value of the previous sample. Specifically, for unrolled DFE, one or more embodiments of the invention will use ±H₁^{E} slicers for even eye samples, and ±H₁^{O} slicers for odd eye samples.

As will be appreciated by those skilled in the art, at least a portion of embodiments of the present invention may be implemented as an apparatus, system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to as a “circuit,” “module,” “block,” or “system.” Furthermore, embodiments of the present invention may take the form of a computer program product embodied in one or more non-transitory machine-readable medium(s) having machine-readable program code embodied thereon.

One or more embodiments of the invention, or elements thereof, can be implemented in the form of an apparatus including a memory and at least one processor coupled with the memory and operative to perform exemplary method steps in accordance with embodiments of the invention.

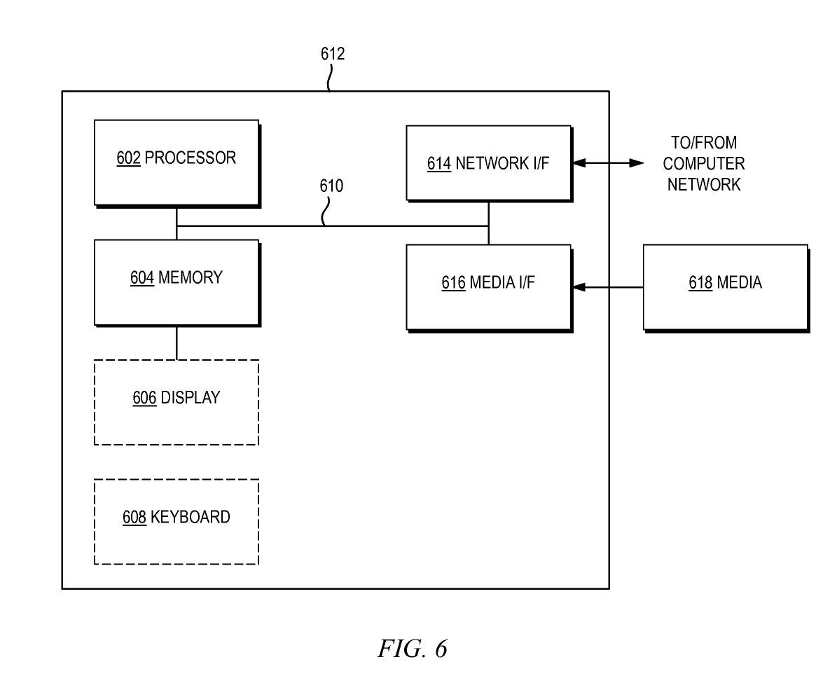

One or more embodiments of the invention make use of software running on a general purpose computer or workstation which, when configured by the software, is transformed into a special purpose machine operative to perform methods in accordance with embodiments described herein. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing methodologies according to embodiments of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly with memory elements 604 through a system bus 610. The memory elements can include local memory employed during actual implementation of the program code, bulk storage, cache memories and embedded memory which provide temporary storage of at least a portion of program code in order to reduce the number of times the code must be retrieved from bulk storage during implementation.

Input/output or I/O devices (including but not limited to keyboards 608, displays 606, pointing devices, and the like) can be coupled to the system either directly (such as via bus 610) or through intervening I/O controllers (omitted for clarity).

Network adapters such as network interface 614 are also coupled with the system, in one or more embodiments of the invention, to enable the data processing system to become coupled with other data processing systems or remote printers or storage devices through intervening private or public networks. Modems, cable modem and Ethernet cards are just a few of the currently available types of network adapters.

As noted, one or more embodiments of the present invention may take the form of a computer program product embodied in one or more non-transitory machine- or computer-readable medium(s) having computer-readable program code embodied thereon. Any combination of one or more computer-readable medium(s) may be utilized. The computer-readable medium may be a computer readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. Media block 618 is a non-limiting example. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In one or more embodiments, a computer-readable storage medium is any tangible medium that can contain or store a program, in a non-transitory manner, for use by or in connection with an instruction execution system, apparatus, or device.

Computer program code for carrying out operations according to one or more embodiments of the invention are written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program code, in one or more embodiments, is loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing functions/acts specified in a flowchart and/or block diagram block or blocks.

The block diagrams in the figures depict illustrative architectures, functionality, and operation of implementations of systems, methods and computer program products according to embodiments of the present invention. In this regard, each block shown in the block diagrams may represent a module, segment, or portion of code, which comprises one or more executable instructions for implementing specified functions. It should also be noted that, in one or more embodiments, functions represented by the blocks may occur out of the order noted in the figures. For example, two blocks shown in succession may, in fact, be executed substantially concurrently, or the blocks may sometimes be executed in the reverse order, depending upon the functionality involved. It will also be appreciated that each block of the block diagrams, and combinations of blocks in the block diagrams, can be implemented by special purpose hardware-based systems that perform the specified functions or acts, or combinations of special purpose hardware and computer instructions.

It should be understood that any of the methods described herein can include an additional step of providing a system comprising distinct software modules embodied on a non-transitory computer-readable storage medium; the modules include, in one or more embodiments, any or all of the elements depicted in the block diagrams and/or described herein; by way of example and without limitation, a linear equalizer, adder, data slicer, deserializer, serializer, decision feedback equalizer and equalization adaptation module. The method steps can then be carried out using the distinct software modules and/or sub-modules of the system, executing on one or more hardware processors 602. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application-specific integrated circuits (ASICs), functional circuitry, one or more appropriately programmed general purpose digital computers with associated memory, and the like. Given the teachings of the invention provided herein, one of ordinary skill in the related art will be able to contemplate other implementations of the components of the invention.

In an integrated circuit implementation of one or more embodiments of the invention, multiple identical die are typically fabricated in a repeated pattern on a surface of a semiconductor wafer. Each such die may include a device described herein, and may include other structures and/or circuits. The individual dies are cut or diced from the wafer, then packaged as integrated circuits. One skilled in the art would know how to dice wafers and package die to produce integrated circuits. Any of the exemplary circuits illustrated in the accompanying figures, or portions thereof, may be part of an integrated circuit. Integrated circuits so manufactured are considered part of this invention.

The illustrations of embodiments of the invention described herein are intended to provide a general understanding of the structure of various embodiments, and they are not intended to serve as a complete description of all the elements and features of apparatus and systems that might make use of the structures described herein. Many other embodiments will become apparent to those skilled in the art given the teachings herein; other embodiments are utilized and derived therefrom, such that structural and logical substitutions and changes can be made without departing from the scope of this disclosure. The drawings are also merely representational and are not drawn to scale. Accordingly, the specification and drawings are to be regarded in an illustrative rather than a restrictive sense.

Embodiments of the invention are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The abstract is provided to comply with 37 C.F.R. §1.72(b), which requires an abstract that will allow the reader to quickly ascertain the nature of the technical disclosure. It is submitted with the understanding that it will not be used to interpret or limit the scope or meaning of the claims. In addition, in the foregoing Written Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, inventive subject matter lies in less than all features of a single embodiment. Thus the following claims are hereby incorporated into the Written Description, with each claim standing on its own as separately claimed subject matter.

Given the teachings of embodiments of the invention provided herein, one of ordinary skill in the art will be able to contemplate other implementations and applications of the techniques of embodiments of the invention. Although illustrative embodiments of the invention have been described herein with reference to the accompanying drawings, it is to be understood that embodiments of the invention are not limited to those precise embodiments, and that various other changes and modifications are made therein by one skilled in the art without departing from the scope of the appended claims.

1. A method for reducing a disparity between even and odd eye characteristics in recovered data, the method comprising:
receiving an input serial data stream;
performing independent data slicing of even and odd components in the serial data stream to generate corresponding even and odd discrete-time data samples, respectively;
performing independent error slicing of even and odd components in the serial data stream to generate corresponding even and odd discrete-time error samples, respectively;
deserializing the even and odd discrete-time data and error samples to generate the recovered data and recovered error, respectively;
controlling respective offsets for error slicing of the even and odd components independently so as to reduce the disparity between even and odd eye characteristics in the recovered data;
amplifying the received input serial data stream to generate an amplified serial data stream, a gain of the amplified serial data stream being controlled as a function of a first control signal;
generating from the recovered data and error, even and odd equalization adaptation coefficients corresponding to the even and odd discrete-time data and error samples, respectively; and
generating the first control signal for controlling the gain of the amplified serial data stream as a function of at least one of an average of the even and odd equalization adaptation coefficients, a greater of the even and odd equalization adaptation coefficients, and a lesser of the even and odd equalization adaptation coefficients.

2. (canceled)

3. The method of claim 1, wherein amplifying the received input serial data stream is performed prior to performing independent data and error slicing of the even and odd components in the serial data stream.

4. (canceled)

5. The method of claim 1, further comprising equalizing the received input serial data stream to generate an equalized serial data stream, at least one parameter of the equalized serial data stream being controlled as a function of a second control signal.

6. The method of claim 5, wherein equalizing the received input serial data stream is performed prior to performing independent data slicing of the even and odd components in the serial data stream.

7. The method of claim 5, further comprising:
generating, from the recovered data and error, even and odd equalization adaptation coefficients corresponding to the even and odd discrete-time data and error samples, respectively; and
generating the second control signal for controlling the at least one parameter of the equalized serial data stream as a function of at least one of an average of the even and odd equalization adaptation coefficients, a greater of the even and odd equalization adaptation coefficients, and a lesser of the even and odd equalization adaptation coefficients.

8. The method of claim 1, wherein controlling respective offsets for error slicing comprises:
generating, from the recovered data and error, even and odd equalization adaptation coefficients corresponding to the even and odd discrete-time error samples, respectively; and
controlling at least one parameter of the error slicing of the even components as a function of the even equalization adaptation coefficients, and controlling at least one parameter of the error slicing of the odd components as a function of the odd equalization adaptation coefficients.

9. The method of claim 1, further comprising:
generating, from the recovered data and error, even and odd equalization adaptation coefficients corresponding to the even and odd discrete-time error samples, respectively; and
performing decision feedback equalization on the equalized serial data stream as a function of the recovered data and the even and odd equalization adaptation coefficients.

10. The method of claim 1, wherein controlling the respective offsets for the error slicing of the even and odd components comprises generating the respective offsets for the error slicing using a least mean squares (LMS) adaptation algorithm.

11. The method of claim 1, wherein at least a portion of the method is performed in a receiver of a local serializer/deserializer (SerDes) device.

12. The method of claim 11, further comprising:
generating, from the recovered data and error, even and odd equalization adaptation coefficients corresponding to the even and odd discrete-time error samples, respectively;
transmitting the even and odd equalization adaptation coefficients to a remote SerDes device via a back channel established between the local and remote SerDes devices; and
performing, in a transmitter of the remote SerDes device, feed-forward equalization on the input serial data stream as a function of at least one of an average of the even and odd equalization adaptation coefficients, a greater of the even and odd equalization adaptation coefficients, and a lesser of the even and odd equalization adaptation coefficients.

13. An apparatus for reducing a disparity between even and odd eye characteristics in recovered data, the apparatus comprising:
a summation element configured to receive an input serial data stream;
first slicers coupled with the summation element and configured to convert even components in the serial data stream into corresponding even discrete-time data samples, transition samples and error samples;
second slicers coupled with the summation element and configured to convert odd components in the serial data stream into corresponding odd discrete-time data samples, transition samples and error samples;
a deserializer coupled with the first and second slicers and configured to deserialize the even and odd discrete-time data and error samples to generate the recovered data and recovered error, respectively;
at least one equalization adaptation module configured to control respective error slicer offsets in the first and second slicers independently so as to reduce the disparity between even and odd eye characteristics in the recovered data; and
a variable gain amplifier, the variable gain amplifier being configured to receive the input serial data stream and to generate an amplified serial data stream supplied to the summation element, a gain of the amplified serial data stream being controlled as a function of a first control signal;
wherein the at least one equalization adaptation module is configured: to generate, from the recovered data and error, even and odd equalization adaptation coefficients corresponding to the even and odd discrete-time error samples, respectively; and to generate the first control signal for controlling the gain of the amplified serial data stream as a function of at least one of an average of the even and odd equalization adaptation coefficients, a greater of the even and odd equalization adaptation coefficients, and a lesser of the even and odd equalization adaptation coefficients.

14. (canceled)

15. (canceled)

16. The apparatus of claim 13, further comprising a linear equalizer, the linear equalizer being configured to receive the input serial data stream and to generate an equalized serial data stream supplied to the summation element, at least one parameter of the equalized serial data stream being controlled as a function of a second control signal.

17. The apparatus of claim 16, wherein the at least one equalization adaptation module is configured: to generate, from the recovered data and error, even and odd equalization adaptation coefficients corresponding to the even and odd discrete-time error samples, respectively; and to generate the second control signal for controlling the at least one parameter of the equalized serial data stream as a function of at least one of an average of the even and odd equalization adaptation coefficients, a greater of the even and odd equalization adaptation coefficients, and a lesser of the even and odd equalization adaptation coefficients.

18. The apparatus of claim 13, further comprising a decision feedback equalizer (DFE) coupled between the deserializer and the summation element in a closed loop feedback configuration, the DFE being configured to utilize information about previously received data samples to reduce intersymbol interference contributions attributable to the previously received data samples from a current data sample decision.

19. The apparatus of claim 18, wherein one or more parameters of the DFE are independently controlled as a function of a first set of control signals corresponding to even decision feedback equalization coefficients and a second set of control signals corresponding to odd decision feedback equalization coefficients supplied to the DFE, wherein the first and second sets of control signals are used to independently control, as a function of even and odd data and error samples in the recovered data and error, respectively, one or more parameters of a decision feedback equalization methodology implemented by the DFE.

20. The apparatus of claim 13, wherein the at least one equalization adaptation module utilizes a least mean squares algorithm to place the error slicer offsets in the first and second slicers in a statistical middle of data eye traces at a prescribed sampling time.

21. The apparatus of claim 13, wherein at least a portion of the apparatus is fabricated in at least one integrated circuit.

22. A method for reducing a disparity between even and odd eye characteristics in recovered data, the method comprising:
receiving an input serial data stream;
performing independent data slicing of even and odd components in the serial data stream to generate corresponding even and odd discrete-time data samples, respectively;
performing independent error slicing of even and odd components in the serial data stream to generate corresponding even and odd discrete-time error samples, respectively;
deserializing the even and odd discrete-time data and error samples to generate the recovered data and recovered error, respectively; and
controlling respective offsets for error slicing of the even and odd components independently so as to reduce the disparity between even and odd eye characteristics in the recovered data, comprising:
generating, from the recovered data and error, even and odd equalization adaptation coefficients corresponding to the even and odd discrete-time error samples, respectively; and
controlling at least one parameter of the error slicing of the even components as a function of the even equalization adaptation coefficients, and controlling at least one parameter of the error slicing of the odd components as a function of the odd equalization adaptation coefficients.

23. The method of claim 22, further comprising equalizing the received input serial data stream to generate an equalized serial data stream, at least one parameter of the equalized serial data stream being controlled as a function of a second control signal.

24. The method of claim 23, wherein equalizing the received input serial data stream is performed prior to performing independent data slicing of the even and odd components in the serial data stream.

25. The method of claim 23, further comprising:
generating, from the recovered data and error, even and odd equalization adaptation coefficients corresponding to the even and odd discrete-time data and error samples, respectively; and
generating the second control signal for controlling the at least one parameter of the equalized serial data stream as a function of at least one of an average of the even and odd equalization adaptation coefficients, a greater of the even and odd equalization adaptation coefficients, and a lesser of the even and odd equalization adaptation coefficients.
